(19) United States
(12) Patent Application Publication
(10) Pub. No.: US 2009/0144650 A1
(43) Pub. Date: Jun. 4, 2009

(54) MULTIMEDIA APPARATUS TO SUPPORT MULTIPLE LANGUAGES AND METHOD FOR PROVIDING MULTILINGUAL USER INTERFACE FOR THE SAME

(75) Inventor: Jin-sook YOON, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/128,925

(22) Filed: May 29, 2008

(30) Foreign Application Priority Data
Dec. 4, 2007 (KR) 2007-125084

(51) Int. Cl. G06F 3/048

(52) U.S. Cl. 715/780

(57) ABSTRACT

A multimedia apparatus and a user interface (UI) for multiple languages. The multimedia apparatus determines a function of an input user command according to a direction in which a set language is written, so users can use a multimedia apparatus supporting multiple languages more naturally.

### CROSS-REFERENCE TO RELATED APPLICATION

This application claims the benefit of Korean Application No. 2007-125084, filed in the Korean Intellectual Property Office on Dec. 4, 2007, the disclosure of which is incorporated herein by reference.

### BACKGROUND OF THE INVENTION

1. Field of the Invention

Aspects of the present invention relate to a multimedia apparatus and a method of providing a user interface (UI) for the same, and more particularly, to a multimedia apparatus which supports multiple languages and a method of providing a multilingual UI for the same.

2. Description of the Related Art

Multimedia apparatuses, such as MP3 players, are manufactured in a few countries and distributed worldwide, and thus need to support multiple languages. Most languages are generally written from left to right. However, some languages, such as Arabic, are written from right to left, and therefore are displayed from right to left in multimedia apparatuses.

People who use a language written from left to right and people who use a language written from right to left may have opposite ways of thinking regarding direction. However, in existing multimedia apparatuses supporting Arabic, if the displayed language is Arabic, only the language is displayed from right to left, but other functions remain unchanged. As a result, when Arab people, having a way of thinking opposite that of people using languages written from left to right, use multimedia apparatuses designed for languages written from left to right, they may be inconvenienced. Therefore, there is a need for methods for the users to use multimedia apparatuses supporting multiple languages with greater convenience.

### SUMMARY OF THE INVENTION

Aspects of the present invention provide a multimedia apparatus and user interface (UI) that determines a function of a command according to the direction in which a language is written, so that users can use the multimedia apparatus supporting multiple languages with greater convenience.

Additional aspects of the present invention provide a multimedia apparatus and UI which determine a function of a command according to the display direction of a graphical user interface (GUI).

According to an aspect of the present invention, a multimedia apparatus is provided. The multimedia apparatus includes an input unit to receive a user command, and a control unit to determine a function of the input user command according to a direction in which a set language is written.

According to another aspect of the present invention, the control unit determines the function of the input user command regarding a direction according to the direction in which the set language is written.

According to another aspect of the present invention, the control unit changes the function of the input user command so as to operate in an opposite direction if the set language is changed to a language which is written in a direction opposite to the direction in which the set language is written.

According to another aspect of the present invention, the user command is a command regarding a left direction key or a right direction key.

According to another aspect of the present invention, the function is a function of moving between higher menus and lower menus.

According to another aspect of the present invention, the direction in which the set language is written is left to right or right to left.

According to another aspect of the present invention, the control unit determines that the right direction key has a function of moving from a lower menu to a higher menu if the set language is written from right to left.

According to another aspect of the present invention, the control unit determines that the left direction key has a function of moving from a higher menu to a lower menu if the set language is written from right to left.

According to another aspect of the present invention, the set language is Arabic.

According to another aspect of the present invention, a method for providing a user interface (UI) is provided. The method includes setting a language to be used, receiving a user command, and determining a function corresponding to the input user command according to the direction in which the set language is written.

According to another aspect of the present invention, the determining of the function comprises determining the function of the input user command regarding a direction is determined according to the direction in which the set language is written.

According to another aspect of the present invention, the method further includes changing the function of the input user command so as to operate in an opposite direction if the set language is changed to a language which is written in a direction opposite the direction in which the set language is written.

According to another aspect of the present invention, the determining of the function comprises determining that the right direction key has a function of moving from a lower menu to a higher menu if the set language is written from right to left.

According to another aspect of the present invention, the determining of the function comprises determining that the left direction key has a function of moving from a higher menu to a lower menu if the set language is written from right to left.

According to another aspect of the present invention, a multimedia apparatus is provided. The multimedia apparatus includes an input unit to receive a user command, and a control unit to determine a function of the input user command according to a display direction of a graphical user interface (GUI).

According to another aspect of the present invention, the control unit determines the function of the input user command regarding a direction to correspond to the display direction of the GUI.

According to another aspect of the present invention, the function is a function of moving between a higher menu and a lower menu.

According to another aspect of the present invention, a method for providing a user interface (UI) is provided. The method includes receiving a user command, and determining a function of the input user command according to a display direction of a graphical user interface (GUI).

According to another aspect of the present invention, the determining of the function comprises determining the function of the input user command regarding a direction to correspond to the display direction of the GUI.

According to another aspect of the present invention, the function is a function of moving between a higher menu and a lower menu.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a MP3 player according to an embodiment of the present invention;

FIG. 2 is a flowchart of a process of providing a multilingual UI according to an embodiment of the present invention;

FIG. 3 shows screens illustrating the function of a direction key in a basic mode according to an embodiment of the present invention; and

FIG. 4 shows screens illustrating the function of a direction key in the Arabic mode according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

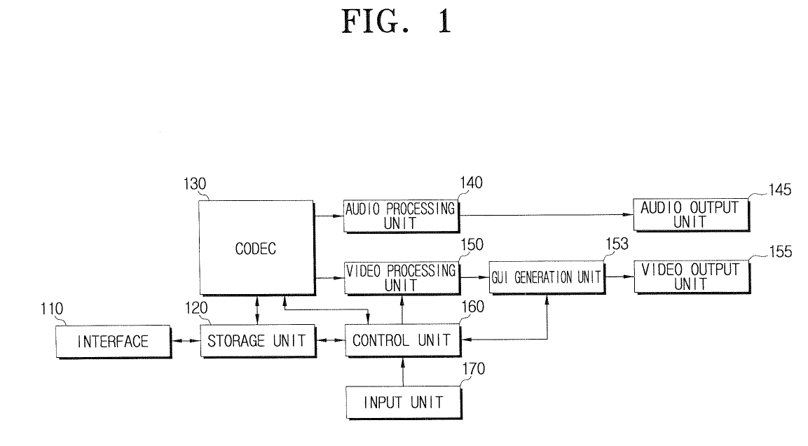

FIG. 1 shows an MP3 player according to an embodiment of the present invention. As shown in FIG. 1, the MP3 player includes an interface 110, a storage unit 120, a coder/decoder (CODEC) 130, an audio processing unit 140, an audio output unit 145, a video processing unit 150, a graphical user interface (GUI) generation unit 153, a video output unit 155, a control unit 160, and an input unit 170. According to other aspects of the present invention, the MP3 player may include additional and/or different units. Similarly, the functionality of two or more of the above units may be integrated into a single component.

The interface 110 connects the MP3 player to a computer. The MP3 player downloads multimedia files from the computer through the interface 110, and uploads multimedia files to the computer through the interface 110. The storage unit 120 stores multimedia files, such as music files, video files, and/or text files, as well as programs that operate the MP3 player.

The CODEC 130 compresses or decompresses multimedia files. The CODEC 130 decompresses the multimedia files stored in the storage unit 120, and transmits the decompressed multimedia files to the audio processing unit 140 and the video processing unit 150. The audio processing unit 140 processes audio signals received from the CODEC 130. For example, the audio processing unit 140 performs volume control, noise removal, and equalizing, and outputs the processed audio signals to the audio output unit 145.

The audio output unit 145 outputs the audio signals output by the audio processing unit 140 to a speaker or to an external device connected through an external output terminal. The video processing unit 150 processes video signals output from the CODEC 130 by video scaling, and outputs the processed video signals to the GUI generation unit 153.

The GUI generation unit 153 generates a GUI to be displayed on a display, and adds the GUI to video output from the video processing unit 150. The video output unit 155 displays the video together with the GUI output from the GUI generation unit 153 on the display or outputs the video together with the GUI to the external device connected through the external output terminal.

The input unit 170 receives input of user commands from the user, and transmits the user commands to the control unit 160. The input unit 170 may be implemented using key buttons, a wheel, a touchpad, a touch screen, or other input device.

The control unit 160 determines the user commands received from the input unit 170, and controls the overall operation of the MP3 player based on the user commands. The control unit 160 determines a function of a user command according to the direction in which a set language is written. In addition, the control unit 160 determines a function of a user command according to the display direction of a GUI.

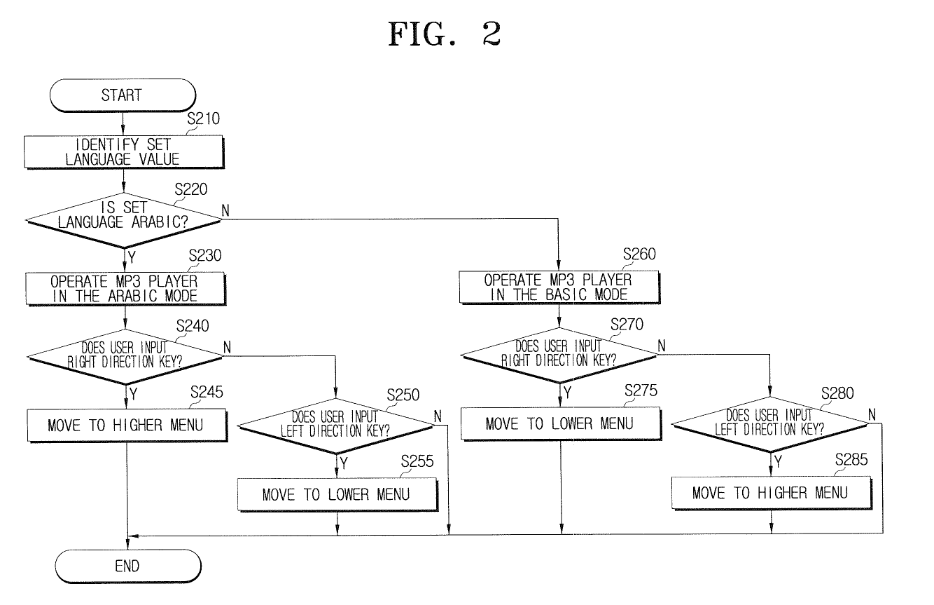

The operation of the control unit 160 is described in more detail with reference to FIG. 2. FIG. 2 is a flowchart of a process of providing a multilingual UI according to an embodiment of the present invention. The control unit 160 identifies a set language value in operation S210. The language value may be set by the user or may be pre-set at the time of manufacture.

The control unit 160 determines whether the set language is Arabic in operation S220. Arabic, unlike most other languages, is written from right to left. If the set language is Arabic, the control unit 160 operates the MP3 player in an Arabic mode in operation S230. In the Arabic mode, the basic language is set to be Arabic. Moreover, functions are added according to the right-left direction of Arabic. For example, text is displayed from right to left and aligned to the right.

Subsequently, the control unit 160 determines whether the user inputs a right direction key in operation S240. If the user inputs the right direction key, the control unit 160 moves from a currently displayed menu to a higher menu in operation S245. If the user does not input the right direction key, the control unit 160 determines whether or not the user inputs a left direction key in operation S250. If the user inputs the left direction key, the control unit 160 moves from the currently displayed menu to a lower menu in operation S255.

Generally, people using languages that are written from left to right understand the left direction key to have a function of moving to a higher menu and the right direction key to have a function of moving to a lower menu. However, people using a language such as Arabic, which is written from right to left, understand the left direction key to have a function of moving to a lower menu and the right direction key to have a function of moving to a higher menu. Therefore, in the Arabic mode, the direction keys have the functions described above.

In operation S260, if the set language is not Arabic, the control unit 160 operates the MP3 player in a basic mode. In the basic mode, a language is written from left to right. Accordingly, the control unit 160 displays text from left to right and aligns text to the left.

If the user inputs the right direction key, the control unit 160 moves from a currently displayed menu to a lower menu in operation S275. If the user inputs the left direction key, the control unit 160 moves from the currently displayed menu to a higher menu in operation S285.

As described above, the control unit 160 determines the function of the input direction key differently according to the direction in which a set language is written, so people using Arabic can intuitively use the direction key. In addition, if the user changes the language from Arabic to Korean, the control unit 160 controls the function of the direction key in a reverse manner since the language is changed to a language written in the opposite direction.

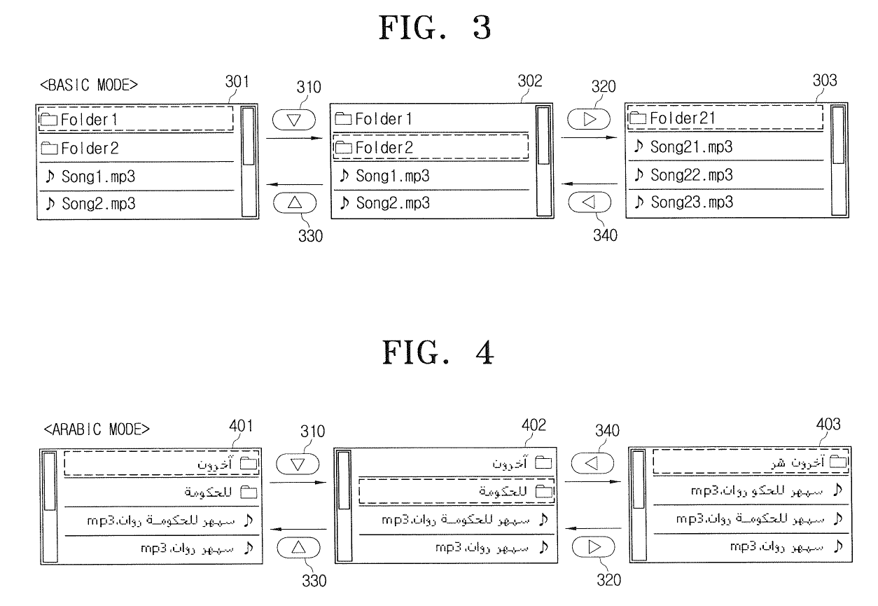

Screens implementing the function described above are described in detail with reference to FIGS. 3 and 4. FIG. 3 shows screens illustrating the function of the direction key in the basic mode according to an embodiment of the present invention, and FIG. 4 shows screens illustrating the function of the direction key in the Arabic mode according to an embodiment of the present invention.

In FIG. 3, the language is set to be English. Since English is written from left to right, the basic mode is applied, and text is displayed from left to right and aligned to the left. The first screen 301 displays multimedia files stored in the storage unit 120 of the MP3 player, and a first item in the first screen 301 is highlighted.

If the user presses a down direction key 310, a second item is highlighted as shown in the second screen 302. If the user presses the down direction key 310, the highlight moves down.

If the user presses the right direction key 320, files stored in “Folder 2”, which is the second item in the menu, are displayed as shown in the third screen 303. The third screen 303 displays the contents of Folder 2, which is displayed in the second screen 302, as a sub-menu. Therefore, in the basic mode, the right direction key 320 performs the function of moving to lower menu. If the user presses the left direction key 340, the third screen 303 is replaced by the second screen 302. In the basic mode, the left direction key 340 performs the function of moving to a higher menu. Subsequently, if the user presses an up direction key 330, the highlight moves up by one block as shown in the first screen 301.

As described above, in the basic mode, used when the language is set to English, the right direction key 320 performs the function of moving to a lower menu and the left direction key 340 performs the function of moving to a higher menu.

In FIG. 4, the language is set to Arabic. Since Arabic is written from right to left, the Arabic mode is applied. As shown in FIG. 4, text is displayed from right to left and aligned to the right. The fourth screen 401 displays multimedia files stored in the storage unit 120 of the MP3 player, the first item of which is highlighted. If the user presses the down direction key 310, a second item is highlighted as shown in the fifth screen 402. If the user presses the down direction key 310, the highlight moves down.

If the user presses the left direction key 340, the files stored in a folder of the second item are displayed as shown in the sixth screen 403. The sixth screen 403 displays the contents of the folder listed as the second item in the fifth screen 402. In the Arabic mode, the left direction key 340 performs the function of moving to a lower menu.

If the user presses the right direction key 320, the sixth screen 403 is replaced by the fifth screen 402. In the Arabic mode, the right direction key 320 performs the function of moving to a higher menu. Subsequently, if the user presses the up direction key 330 in the fifth screen 402, the highlight moves up by one block as shown in the fourth screen 401.

As described above, in the Arabic mode in which the language is set to Arabic, the right direction key 320 performs the function of moving to a higher menu and the left direction key 340 performs the function of moving to a lower menu. Accordingly, the left and right direction keys in the Arabic mode have opposite functions to those used in the basic mode. The function of the direction key changes according to the direction in which the set language is read.

People using a language written from right to left can intuitively use the direction key by implementing a function of the direction key to change according to the direction in which the set language is written.

The key which changes according to the direction in which a language is written is the direction key, but according to other aspects of the present invention, keys other than the direction key may be implemented to change according to the direction in which a language is read. For example, the control unit 160 may also control a fast forwarding key and a rewinding key to have functions in the Arabic mode opposite those used in the basic mode.

Aspects of the present invention may be applied to diverse languages which are written from right to left other than Arabic, such as Hebrew. In addition, aspects of the present invention may also be applied to languages written vertically.

According to other aspects of the present invention diverse functions other than the function of moving between higher and lower menus can be implemented to change. Similarly, functions of key buttons may be implemented to change according to the overall display direction of a GUI other than the direction in which a language is written. The display direction of the GUI includes the display direction of text, and the direction of playing back multimedia files. For example, in a mode where lower menus are displayed to the left of higher menus in a GUI, the control unit 160 controls a left direction key to perform a function of moving to lower menus. However, in a mode where lower menus are displayed to the right of higher menus in the GUI, the control unit 160 controls the left direction key to perform a function of moving to higher menus.

The multimedia apparatus described is an MP3 player, but the multimedia apparatus may also be a device other than an MP3 player. For example, aspects of the present invention can be applied to portable media players (PMP), cellular phones, and personal digital assistants (PDA).

According to aspects of the present invention, a multimedia apparatus and an UI for multiple languages are provided which determine a function of a command according to the direction in which a language is written so that users can use the multimedia apparatus supporting multiple languages more conveniently. Since a function of a command can be determined according to the direction in which a language is written, people using languages which are written from right to left can use the multimedia apparatus and UI more naturally according to their way of thinking.

Moreover, since a function of a command is determined according to the display direction of the GUI, functions can change according to the overall display direction of the GUI other than the direction in which a language is written. Therefore, users can intuitively use the functions according to the display direction of the GUI.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multimedia apparatus, comprising:
an input unit to receive a user command; and
a control unit to determine a function of the input user command according to a direction in which a set language is written.

2. The multimedia apparatus according to claim 1, wherein the control unit determines the function of the input user command regarding a direction according to the direction in which the set language is written.

3. The multimedia apparatus according to claim 1, wherein the control unit changes the function of the input user command so as to operate in an opposite direction if the set language is changed to a language which is written in a direction opposite to the direction in which the set language is written.

4. The multimedia apparatus according to claim 1, wherein the user command is a command regarding a left direction key or a right direction key.

5. The multimedia apparatus according to claim 1, wherein the function is a function of moving between higher menus and lower menus.

6. The multimedia apparatus according to claim 1, wherein the direction in which the set language is written left to right or right to left.

7. The multimedia apparatus according to claim 1, wherein the control unit determines that the right direction key has a function of moving from a lower menu to a higher menu if the set language is written from right to left.

8. The multimedia apparatus according to claim 1, wherein the control unit determines that the left direction key has a function of moving from a higher menu to a lower menu if the set language is written from right to left.

9. The multimedia apparatus according to claim 1, wherein the set language is Arabic.

10. A method for providing a user interface (UI), the method comprising:
setting a language to be used;
receiving a user command; and
determining a function corresponding to the input user command according to the direction in which the set language is written.

11. The method according to claim 10, wherein in determining of the function comprises determining the function of the input user command regarding a direction according to the direction in which the set language is written.

12. The method according to claim 10, further comprising changing the function of the input user command so as to operate in an opposite direction if the set language is changed to a language which is written in a direction opposite the direction in which the set language is written.

13. The method according to claim 10, wherein the user command is a command regarding a left direction key or a right direction key.

14. The method according to claim 10, wherein the function is a function of moving between a higher menu and a lower menu.

15. The method according to claim 10, wherein the direction in which the set language is written is left to right or right to left.

16. The method according to claim 10, wherein the determining of the function comprises determining that the right direction key has a function of moving from a lower menu to a higher menu if the set language is written from right to left.

17. The method according to claim 10, wherein the determining of the function comprises determining that the left direction key has a function of moving from a higher menu to a lower menu if the set language is written from right to left.

18. The method according to claim 10, wherein the set language is Arabic.

19. A multimedia apparatus, comprising:
an input unit to receive a user command; and
a control unit to determine a function of the input user command according to a display direction of a graphical user interface (GUI).

20. The multimedia apparatus according to claim 19, wherein the control unit determines the function of the input user command regarding a direction to correspond to the display direction of the GUI.

21. The multimedia apparatus according to claim 19, wherein the function is a function of moving between a higher menu and a lower menu.

22. A method for providing a user interface (UI), the method comprising:
receiving a user command; and
determining a function of the input user command according to a display direction of a graphical user interface (GUI).

23. The method according to claim 22, wherein the determining of the function comprises determining the function of the input user command regarding a direction to correspond to the display direction of the GUI.

24. The method according to claim 22, wherein the function is a function of moving between a higher menu and a lower menu.

25. The method according to claim 10, wherein the determining of the function comprises determining that the right direction key has a function of moving from a higher menu to a lower menu if the set language is written from left to right.

26. The method according to claim 10, wherein the determining of the function comprises determining that the left direction key has a function of moving from a lower menu to a higher menu if the set language is written from left to right.

27. A method of providing a user interface, the method comprising:
receiving a key input signal; and
determining a function corresponding to the key input signal based on a language of the user interface; and
performing the function corresponding to the key input signal.

28. The method according to claim 27, wherein the determining of the function comprises determining the function based on whether the language is written from right to left or from left to right.

29. The method according to claim 27, wherein the function is a function of moving from a higher level menu to a lower level menu, or from a lower level menu to a higher level menu.

30. A multimedia apparatus, comprising:
a display;
an input unit to receive a key input signal from a user; and
a controller to determine a function corresponding to the key input signal based on a language of a user interface, to control the multimedia apparatus to perform the function, and to display the result of performing the function on the display, if necessary.

31. The multimedia apparatus of claim 30, wherein the controller determines the function based on whether the language is written from right to left or from left to right.

32. The multimedia apparatus of claim 30, wherein the function is a function to move from a higher level menu to a lower level menu or from a lower level menu to a higher level menu.

33. The multimedia apparatus of claim 30, wherein the multimedia apparatus is an MP3 player.
